(19) United States
(12) Patent Application Publication
(10) Pub. No.: US 2015/0085715 A1
(43) Pub. Date: Mar. 26, 2015

(54) METHOD AND DEVICE FOR TRANSMITTING SIGNAL ON SPECIAL SUB-FRAME IN TDD SYSTEM

(71) Applicant: Samsung Electronics Co., Ltd., Suwon-si, Gyeonggi-do (KR)

(72) Inventors: Chengjun Sun, Beijing (CN); Yingyang Li, Beijing (CN)

(73) Assignee: Samsung Electronics Co., Ltd., Suwon-si, Gyeonggi-do (KR)

(21) Appl. No.: 14/386,196

(22) PCT Filed: Mar. 13, 2013
(86) PCT No.: PCT/KR2013/001996

§ 371 Date: Sep. 18, 2014

(30) Foreign Application Priority Data
Mar. 19, 2012 (CN) 201210073180.7

(51) Int. Cl. H04L 5/14; H04L 27/26; H04W 88/08

(52) U.S. Cl. CPC H04L 5/1469; H04W 88/08; H04L 27/2626
USPC 370/280

(57) ABSTRACT

A method for configuring a special sub-frame of Long Term Evolved (LTE) Time Division Duplex (TDD) is provided. The method includes transmitting, by a base station a new signaling to configure special sub-frame configuration and related control parameters for the new User Equipment (UE); scheduling, by the base station, the uplink or downlink transmission of the new UE on the special sub-frame according to the special sub-frame configuration contained in the new signaling; performing, by the base station and the UE of the new version. downlink or uplink transmission on the special sub-frame according to the special sub-frame configuration contained in the new signaling and the scheduling of the base station. The base station may fully utilize available downlink resources, so as to increase resource utilization rate.

### CROSS-REFERENCE TO RELATED APPLICATION(S)

This application is a U.S. National Stage application under 35 U.S.C. §371 of an International application filed on Mar. 13, 2013 and assigned application number PCT/KR2013/001996, which claimed the benefit of a Chinese patent application filed on Mar. 19, 2012 in the Chinese Patent Office and assigned Serial number 201210073180.7, the entire disclosure of which is hereby incorporated by reference.

### TECHNICAL FIELD

The present disclosure relates to radio communication technologies. More particularly, the present disclosure relates to a method and device for transmitting a signal on a special sub-frame in a Time Division Duplex (TDD) system.

### BACKGROUND

In a system based In a Long Term Evolved (LTE) system of 3rd Generation Partnership Project (3GPP), downlink transmission technology is Orthogonal Frequency Division Multiple Access (OFDMA) technology, and uplink transmission technology is Single-Carrier-Frequency Division Multiple Access (SC-FDMA) technology. The LTE system supports a Time Division Duplex (TDD) mode.

FIG. 1 is a schematic diagram illustrating a frame structure of a TDD system according to the related art.

Referring to FIG. 1, in the TDD system, the length of each radio frame is 10 ms, and each radio frame is divided into two half frames with the length of 5 ms. Each half frame contains 8 time slots with the length of 0.5 ms and 3 special domains. For a general Cyclic Prefix (CP), each time slot contains 7 OFDM/SC-FDMA symbols. For an extended CP, each time slot contains 6 OFDM/SC-FDMA symbols. Each two continuous general time slots constitute a sub-frame with the length of 1 ms, i.e., the k-th sub-frame contains a time slot 2k and a time slot 2k+1. The total length of the 3 special domains is 1 ms, and the 3 special domains contain sub-frames 1 and 6. The 3 special domains contain a Downlink Pilot Time Slot (DwPTS), a Guard Partition (GP) and an Uplink Pilot Time Slot (UpPTS).

In the frame structure shown in FIG. 1, a sub-frame 0, a sub-frame 5, and the DwPTS are always used for downlink transmission, and a sub-frame 2 and the UpPTS are always used for uplink transmission. Other sub-frames may be configured as uplink sub-frames or downlink sub-frames according to different uplink and downlink configuration. The TDD system supports 7 kinds of uplink and downlink configuration, as shown in Table 1. “D” in Table 1 indicates downlink sub-frames, “U” indicates uplink sub-frames, and S indicates special sub-frames containing the above 3 special domains.

Table 1 shows uplink and downlink configurations in the LTE TDD system.

TABLE 1

| configuration | conversion | | | | | | | | | | |
|---|---|---|---|---|---|---|---|---|---|---|---|
| serial | point | sub-frame index | | | | | | | | | |
| number | period | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | U | D | D | D | D | D | D |
| 6 | 10 ms | D | S | U | U | U | D | S | U | U | D |

For the above special sub-frame (DwPTS/GP/UpPTS), the UpPTS contains one or two SC-FDMA symbols. If the UpPTS contains one SC-FDMA symbol, the UpPTS can only be used for transmitting a Sounding Reference Signal (SRS). If the UpPTS contains two SC-FDMA symbols, the UpPTS may be used for transmitting the SRS, or used for transmitting a random access signal with a format 4, or used for transmitting both the SRS and the random access signal with the format 4. The length of the GP is equal to the length of at least one OFDM/SC-FDMA symbol. Table 2 shows the length of each domain (DwPTS/GP/UpPTS) in the special sub-frame supported by the LET TDD system. When the DwPTS contains 3 OFDM symbols, the DwPTS can only be used for transmitting a control channel and a Primary-Synchronous Channel (P-SCH), but cannot be used for transmitting a Physical Downlink Shared Channel (PDSCH). The DwPTS with other lengths may be used for transmitting a control channel, the P-SCH and the PDSCH.

Table 2 shows configurations of a special sub-frame.

TABLE 2

| config- | normal CP | | | extended CP | | |
|---|---|---|---|---|---|---|
| uration | | UpPTS | | | UpPTS | |
| of special | | normal | extended | | normal | extended |
| sub-frame | DwPTS | CP | CP | DwPTS | CP | CP |
| 0 | 3 | 1 | 1 | 3 | 1 | 1 |
| 1 | 9 | | | 8 | | |
| 2 | 10 | | | 9 | | |
| 3 | 11 | | | 10 | | |
| 4 | 12 | | | 3 | 2 | 2 |
| 5 | 3 | 2 | 2 | 8 | | |
| 6 | 9 | | | 9 | | |
| 7 | 10 | | | — | — | — |
| 8 | 11 | | | — | — | — |

In the 3GPP LTE system, a downlink Transmission Time Interval (TTI) is defined on a sub-frame.

FIG. 2 is a schematic diagram illustrating a structure of a sub-frame according to the related art.

Referring to FIG. 2, for a normal CP, the former n OFDM symbols are used for transmitting downlink control information which contains a PHysical Downlink Control CHannel (PDCCH) and other control information, and the other OFDM symbols are used for transmitting the Physical Downlink Shared CHannel (PDSCH). For a normal sub-frame, n is equal to 1, 2 or 3. For the DwPTS, n is equal to 1 or 2. The granularity of resource allocation is Physical Resource Block (PRB). One PRB contains 12 continuous sub-carriers on frequency, and contains one time slot on time. Two PRBs in two time slots on the same sub-carrier in one sub-frame are called as a PRB pair. For the DwPTS, actual downlink OFDM symbols in one PRB pair are applicable resources. In each PRB pair, each Resource Element (RE) is the smallest unit of time-frequency resources, i.e., each RE is a sub-carrier on frequency and is an OFDM symbol on time. REs may be used for implementing different functions. For example, one part of REs may be used for transmitting a Cell specific Reference Signal (CRS), a subscriber specific Demodulation Reference Signal (DMRS) and a Channel State Information-Reference Signal (CSI-RS) respectively.

In the LTE system, downlink data transmission may be based on the CRS or the DMRS. DMRS based PDSCH transmission is convenient for interference coordination between multiple cells because the DMRS is transmitted only in an allocated PRB. An LTE Advanced system proposes an Enhanced PDCCH (E-PDCCH).

FIG. 3 is a schematic diagram illustrating a multiplexing structure of an E-PDCCH according to the related art.

Referring to FIG. 3, the E-PDCCH is mapped to a data region of sub-frame to be transmitted, and adopts a Frequency Division Multiplexing (FDM) mode together with the PDSCH.

When a Time Division-Synchronous Code Division Multiple Access (TD-SCDMA) system and the LTE TDD system coexist, uplink and downlink transmission of the two systems should be aligned respectively, so as to avoid interference between uplink and downlink signals of the two systems. The length of frame in the TD-SCDMA system is also 10 ms, and one frame is divided into two half frames with the length of 5 ms. Each half frame contains 7 time slots with the length of 675 us and 3 continuous special time slots (DwPTS/GP/UpPTS). The length of the DwPTS is 75 μs, the length of the GP is also 75 μs, and the length of the UpPTS is 125 μs. The 3 special time slots are located between the time slot 0 and the time slot 1. In typical TD-SCDMA configuration, each half frame contains 5 downlink time slots and 2 uplink time slots. In the LTE TDD system, the uplink configuration 2 is compatible with the TD-SCDMA (5DL/2UL), and special sub-frame configuration 5 is adopted (the DwPTS contains 3 OFDM symbols, the length of the GP is equal to the length of 9 OFDM/SC-FDMA symbols, and the UpPTS contains two SC-FDMA symbols).

FIG. 4 is a schematic diagram illustrating a coexistence of TD-SCDMA and LTE TDD according to the related art.

Referring to FIG. 4, when the LTE TDD system adopts the special sub-frame configuration 5, some uplink and downlink resources are wasted. Resources of 3 OFDM symbols on the downlink direction are wasted, and resources of 4 SC-FDMA symbols on the uplink direction are wasted. In the LTE TDD system adopting the extended CP, a similar problem exists. When the special sub-frame configuration 4 is adopted, resources of 2 OFDM symbols on the downlink direction are wasted, and resources of 3 SC-FDMA symbols on the uplink direction are wasted. The utilization rate of uplink and downlink resources may be increased through adding new special sub-frame configuration in the LTE TDD system. However, a frame structure problem introduced by the new special sub-frame configuration should be addressed. Moreover, a new special sub-frame configuration mode is required to make User Equipment (UE) differentiate the new special sub-frame configuration from the special sub-frame configuration implemented through a conventional broadcast signaling.

### SUMMARY

An aspect of the present disclosure is to provide a method and device for transmitting signals on a special sub-frame, so as to provide a new special sub-frame configuration mode.

In order to achieve the above object, the technical solution of the present disclosure is as follows.

In accordance with an aspect of the present invention, a method for transmitting signals on a special sub-frame in a LTE TDD system is provided. The method includes transmitting, by a base station, a new configuration signaling to a User Equipment (UE) of a new version, to configure special sub-frame configuration for the UE of the new version; and performing, by the base station and the UE of new version, uplink or downlink transmission of the UE of new version on the special sub-frame according to the special sub-frame configuration.

In accordance with another aspect of the present invention, a base station is provided. The base station includes a special sub-frame configuring module and a Downlink Pilot Time Slot (DwPTS) processing module. The special sub-frame configuring module is configured to transmit a new configuring signaling to a User Equipment (UE) of a new version to notify the UE of the new version of special sub-frame configuration; and the DwPTS processing module is configured to schedule and transmit a Physical Downlink Shared Channel (PDSCH) on a DwPTS for the UE of the new version according to the special sub-frame configuration.

In accordance with another aspect of the present invention, a UE is provided. The UE includes a special sub-frame configuration receiving module and a DwPTS processing module. The special sub-frame configuration receiving module is configured to receive a broadcast signaling and a new configuration signaling transmitted by a base station, and configure special sub-frame configuration of the UE according to the new configuration signaling; and the DwPTS processing module is configured to receive scheduling information and a Physical Downlink Shared Channel (PDSCH) in a DwPTS according to the special sub-frame configuration configured by the special sub-frame configuration receiving module.

In accordance with another aspect of the present invention, a base station is provided. The base station includes a special sub-frame configuring module and an Uplink Pilot Time Slot (UpPTS) processing module. The special sub-frame configuring module is configured to transmit a new configuring signaling to a UE of a new version to notify the UE of the new version of special sub-frame configuration; and the UpPTS processing module is configured to receive a Sounding Reference Signals (SRS) to the UE of new version according to the special sub-frame configuration of the UE of the new version.

In accordance with another aspect of the present invention, a UE is provided. The UE includes a special sub-frame configuration receiving module and an Uplink Pilot Time Slot (UpPTS) processing module. The special sub-frame configuration receiving module is configured to receive a broadcast signaling and a new configuration signaling transmitted by a base station, and to configure special sub-frame configuration of the UE according to the new configuration signaling; and the UpPTS processing module is configured to transmit a SRS in an UpPTS according to the special sub-frame configuration configured by the special sub-frame configuration receiving module.

In accordance with another aspect of the present invention, a method for transmitting signals on a special sub-frame of LTE TDD is provided. The method includes receiving, at a User Equipment (UE), a new configuration signaling to configure special sub-frame configuration for the UE, and performing, at the UE, uplink and downlink transmission on the special sub-frame according to the new configuration signaling.

As can be seen from the above technical solution, the base station may fully utilize available downlink resources, so as to increase the resource utilization rate. The base station has larger flexibility, and may determine to perform the CRS based downlink data transmission or the DMRS based downlink data transmission for the UE of new version. When there is no CRS in the data region of the DwPTS configured by the base station for the UE of new version and the base station makes the UE of new version adopt DMRS based data transmission, it is easy to implement interference coordination and use Coordinated Multi-Point (CoMP) technology to improve system performance. Through the method of the present disclosure, the capacity of SRS in the LTE TDD system is increased, and the SRS transmission on the normal sub-frame may be avoided, so as to decrease the influence on the PUSCH and the PUCCH.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating a frame structure of a LTE TDD system according to the related art;

FIG. 2 is a schematic diagram illustrating a structure of a sub-frame according to the related art;

FIG. 3 is a schematic diagram illustrating a multiplexing structure of an Enhanced Physical Downlink Control CHannel (E-PDCCH) according to the related art;

FIG. 4 is a schematic diagram illustrating a coexistence of Time Division-Synchronous Code Division Multiple Access (TD-SCDMA) and Long Term Evolution (LTE) Time Division Duplex (TDD);

FIG. 5 is a schematic flowchart illustrating an exemplary embodiment of the present disclosure;

FIG. 6 is a schematic diagram illustrating the structure of CRS on a Downlink Pilot Time Slot (DwPTS) according to an exemplary embodiment of the present disclosure;

FIG. 7 is a schematic diagram illustrating a structure of Demodulation Reference Signal (DMRS) of normal Cyclic Prefix (CP) according to an exemplary embodiment of the present disclosure;

FIG. 8 is a schematic diagram illustrating a structure of DMRS of normal CP according to an exemplary embodiment of the present disclosure;

FIG. 9 is a schematic diagram illustrating a structure of DMRS of extended CP according to an exemplary embodiment of the present disclosure;

FIG. 10 is a schematic diagram illustrating a structure of DMRS of extended CP according to an exemplary embodiment of the present disclosure;

FIG. 11 is a schematic diagram illustrating a structure of DMRS of normal CP according to an exemplary embodiment of the present disclosure;

FIG. 12 is a schematic diagram illustrating a structure of DMRS of normal CP according to an exemplary embodiment of the present disclosure;

FIG. 13 is a schematic diagram illustrating a structure of DMRS of extended CP according to an exemplary embodiment of the present disclosure;

FIG. 14 is a schematic diagram illustrating a structure of a base station according to an exemplary embodiment of the present disclosure;

FIG. 15 is a schematic diagram illustrating a structure of User Equipment (UE) according to an exemplary embodiment of the present disclosure;

FIG. 16 is a schematic diagram illustrating a structure of a base station according to an exemplary embodiment of the present disclosure; and

FIG. 17 is a schematic diagram illustrating a structure of UE according to an exemplary embodiment of the present disclosure.

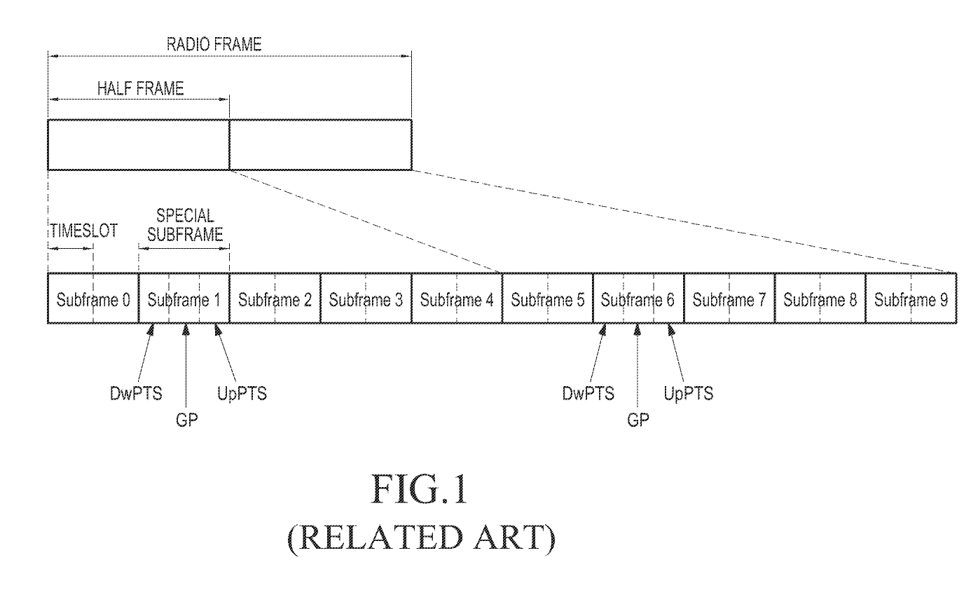

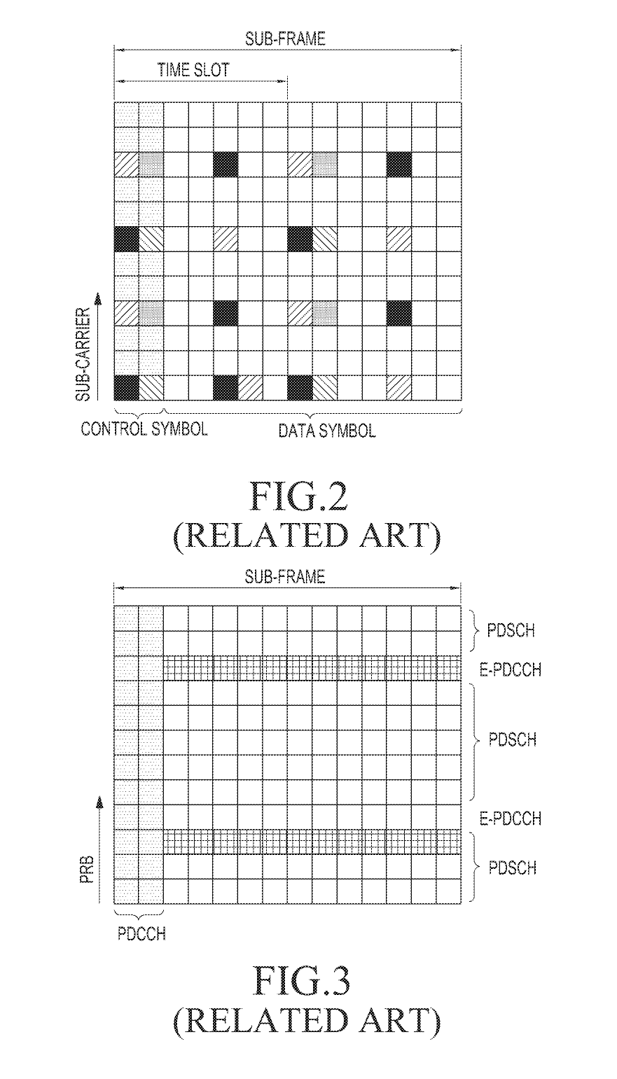

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

In order to improve the downlink resource utilization rate and/or uplink resource utilization rate of Long Term Evolution (LTE) Time Division Duplex (TDD) system, a new special sub-frame configuration may be defined. There are two solutions for defining the new special sub-frame configuration. In one solution, the number of Single-Carrier-Frequency Division Multiple Access (SC-FDMA) symbols in an Uplink Pilot Time Slot (UpPTS) is kept unchanged, and the number of OFDM symbols in an additional Downlink Pilot Time Slot (DwPTS) is increased. In the other solution, both the number of SC-FDMA symbols in the UpPTS and the number of Orthogonal Frequency Division Multiplexing (OFDM) symbols in the DwPTS are increased. Accordingly, there are two problems to be solved: how to support the DwPTS with the new length and the UpPTS with the new length. The embodiments of the present disclosure will be illustrated respectively hereinafter, so as to implement the new sub-frame configuration.

In an LTE TDD system according to the related art, a broadcast signaling may be used for notifying a User Equipment (UE) of special sub-frame configuration of current cell, i.e., the number of OFDM symbols in the DwPTS and the number of SC-FDMA symbols in the UpPTS. In order to improve system flexibility, in embodiments of the present disclosure, the base station transmits a new signaling for configuring a special sub-frame. All UEs which can recognize the new signaling work according to the new signaling. The new signaling may be only used for configuring one piece of special sub-frame configuration defined in the LTE TDD specification, or may be only used for configuring new special sub-frame configurations other than the special sub-frame configuration defined in the LTE TDD specification. The new signaling may also be used for configuring the special sub-frame configuration defined in the conventional LTE TDD specification or configuring one piece of new special sub-frame configuration except the special sub-frame configuration defined in the conventional LTE TDD specification.

In order to be convenient for description, in embodiments of the present disclosure, the UEs which can recognize the new signaling are called as UEs of new version (called as new UEs for short), and the UEs which cannot recognize the new signaling are called as UEs of old version (called as old UEs for short). The new signaling may be a cell specific signaling, which is usually a broadcast signaling, so that all new UEs in the cell may work according to the new signaling. The new signaling may also be a UE specific signaling, which is usually a RRC signaling, so that the base station may configure special sub-frame configuration for each new UE respectively. The special sub-frame configuration of different UEs may be different. If the base station does not transmit the new signaling to the new UE, the new UE works according to the special sub-frame configuration contained in the broadcast signaling of the LTE TDD system.

FIG. 5 is a schematic flowchart illustrating an exemplary embodiment of the present disclosure.

Referring to FIG. 5, in operation 501, the base station transmits a new signaling to configure special sub-frame configuration and related control parameters for the new UE.

Compared with the special sub-frame configuration contained in the broadcast signaling of the LTE TDD system, the special sub-frame configuration contained in the new signaling may be the number of OFDM symbols in the DwPTS which is different from that of the special sub-frame configuration contained in the broadcast signaling according to the related art, or the number of SC-FDMA symbols in the UpPTS which is different from that of the special sub-frame configuration contained in the broadcast signaling according to the related art, or both the number of OFDM symbols in the DwPTS which is different from that of the special sub-frame configuration contained in the broadcast signaling according to the related art and the number of SC-FDMA symbols in the UpPTS which is different from that of the special sub-frame configuration contained in the broadcast signaling according to the related art.

In operation 502, the base station schedules the uplink or downlink transmission of the new UE on the special sub-frame according to the special sub-frame configuration contained in the new signaling.

In operation 503, the new UE performs downlink or uplink transmission on the special sub-frame according to the special sub-frame configuration contained in the new signaling and the scheduling of the base station.

The DwPTS processing method of exemplary embodiments of the present disclosure is described below.

In a typical application scenario, the broadcast signaling according to the related art is used to notify the old UE of that the number of OFDM symbols in the DwPTS is 3, that is to say, the old UE cannot transmit the Physical Downlink Shared Channel (PDSCH) on the DwPTS. Therefore, broadcast information cannot be transmitted on the DwPTS. Through the new signaling, the base station notifies the new UE of special sub-frame configuration in which the number of OFDM symbols of a new DwPTS is not 3. The base station may transmit the PDSCH on the DwPTS only for the new UE. Since the base station transmits the PDSCH only for the new UE, a backward compatible problem may be solved, so as to better support some new characteristics, e.g., Enhanced Physical Downlink Control Channel (E-PDCCH) based PDSCH transmission.

In another application scenario, the broadcast signaling according to the related art is used to notify the old UE of that the number of OFDM symbols in the DwPTS is not 3 (i.e., the old UE may transmit the PDSCH on the DwPTS and may transmit broadcast information on the DwPTS). Through the new signaling, the base station notifies the new UE another number of OFDM symbols in the DwPTS. In this way, the base station may transmit the PDSCH for the new UE according to the other number of OFDM symbols in the DwPTS, so as to improve the flexibility of processing the PDSCH by the base station.

A specific mode of transmitting the PDSCH on the DwPTS for the new UE is described below. The following PDSCH transmission mode may be adopted no matter whether the special sub-frame configuration indicated by the new signaling is one piece of the special sub-frame configuration defined by the LTE TDD specification or new special sub-frame configuration other than the special sub-frame configuration defined by the LTE TDD specification.

In the LTE system, the PDSCH transmission based on two types of reference signals (i.e., Cell specific Reference Signal (CRS) and Demodulation Reference Signal (DMRS)) is supported. In the CRS based data transmission, UEs in a cell share the same reference signal to demodulate data. However, it is difficult to implement interference coordination between cells in the CRS based data transmission. For example, the PDSCHs of UEs in different cells may be soft-multiplexed through a frequency division mode, but it is difficult to coordinate CRSs of different cells. The reasons are as follows. For a case that 2 or 4 CRS ports are configured, the CRS actually has 3 effective frequency offsets; when laying out the 3 frequency offsets between adjacent cells, two cells with stronger interference may be allocated with the same CRS port. In addition, the CRS means that the base station still needs to transmit reference signals even if the CRS does not transmit the PDSCH, which wastes energy. Accordingly, in subsequent versions of LTE, the PDSCH transmission based on UE specific DMRS is paid attention to increasingly. The advantages of DMRS include that the base station transmits reference signals only on the Physical Resource Block (PRB) transmitted to the UE, and the reference signals of UEs in different cells may be soft-multiplexed through the frequency division mode. When the base station does not need to transmit the PDSCH, it is not needed to transmit the reference signals, so as to save power at the base station.

For the special sub-frame configuration configured by the base station for the new UE, the present disclosure provides two methods for transmitting the PDSCH on the DwPTS for the new UE.

In one method, for the special sub-frame configuration configured for the new UE, the CRS is not transmitted on OFDM symbols except 1 or 2 OFDM symbols in the front of DwPTS, and the PDSCH transmission performed for the new UE on the DwPTS is demodulated only based on the DMRS. In this way, the PDSCH is not transmitted on the DwPTS for the old UE. For the new UE, the PDSCH could be transmitted through utilizing the DwPTS resources, so as to better support the interference coordination, and the interference between CRSs and energy waste is avoided.

In the other method, in a signaling for notifying the new UE of the new special sub-frame configuration, it is also configured for the new UE whether there is a CRS except the CRS transmitted on 1 or 2 OFDM symbols in the front of DwPTS. For example, it may be indicated through 1 bit whether there is a CRS. When the signaling indicates that there is the CRS other than the CRS transmitted on 1 or 2 OFDM symbols in the front of DwPTS, it may be defined that only a CRS demodulation based downlink transmission mode may be configured for the new UE, or the downlink transmission mode is not limited (i.e., the CRS demodulation based downlink transmission mode may be configured for the new UE and a DMRS demodulation based downlink transmission mode may also be configured for the new UE). When the signaling indicates that the CRS is not transmitted on OFDM symbols other than 1 or 2 OFDM symbols in the front of DwPTS, only the DMRS demodulation based downlink transmission mode can be configured for the new UE in the DwPTS. Through this method, the base station has larger flexibility, and can determine to perform the CRS based downlink data transmission or the DMRS based downlink data transmission for the new UE.

In the above two methods, since the CRS is not transmitted on OFDM symbols other than 1 or 2 OFDM symbols in the front of DwPTS, resource overhead may be decreased. The reasons are as follows. For the DMRS based PDSCH transmission, the CRS transmitted in the data region of the DwPTS cannot transmit any useful data other than waste some Resource Element (RE) resources. At the same time, since the CRS cannot be pre-encoded, the interference on the PDSCHs of other cells is increased when the PDSCH transmission adopts the Coordinated Multiple Points (CoMP) transmission/reception technology. Especially, for the CoMP Joint Processing (JP) technology, because there is the CRS, multiple adjacent cells cannot utilize the CRS REs to transmit data. The 1 or 2 OFDM symbols mentioned above are the first n OFDM symbols mentioned in the background, which are used for transmitting downlink control information including the PDCCH and other control information.

A reference signal pattern used in the DwPTS of the special sub-frame configuration configured for the new UE will be illustrated hereinafter. If the number of OFDM symbols in the DwPTS of the special sub-frame configuration configured for the new UE is the number of OFDM symbols in a DwPTS that has been defined in the LTE TDD specification, the easiest method is to directly multiplex the reference signal patterns according to the related art including a CRS pattern and a DMRS pattern. However, a new reference signal pattern may be defined in this case, which is not limited in the present disclosure. If the number of OFDM symbols in the DwPTS of the special sub-frame configuration configured for the new UE is different from the number of OFDM symbols in the DwPTS that has been defined in any LTE TDD specification, a method for defining a reference signal pattern based on the CRS and the DMRS is described below.

The CRS pattern may be obtained through truncating the CRS pattern of a normal sub-frame defined in the LTE TDD specification. If the number of OFDM symbols in the DwPTS of the special sum-frame configuration configured for the new UE is N, the CRS pattern is the segment of the former N OFDM symbols of the CRS pattern of the normal sub-frame. For example, suppose the number of OFDM symbols in the DwPTS of the special sum-frame configuration configured for the new UE is 6, and 4 CRS ports are configured.

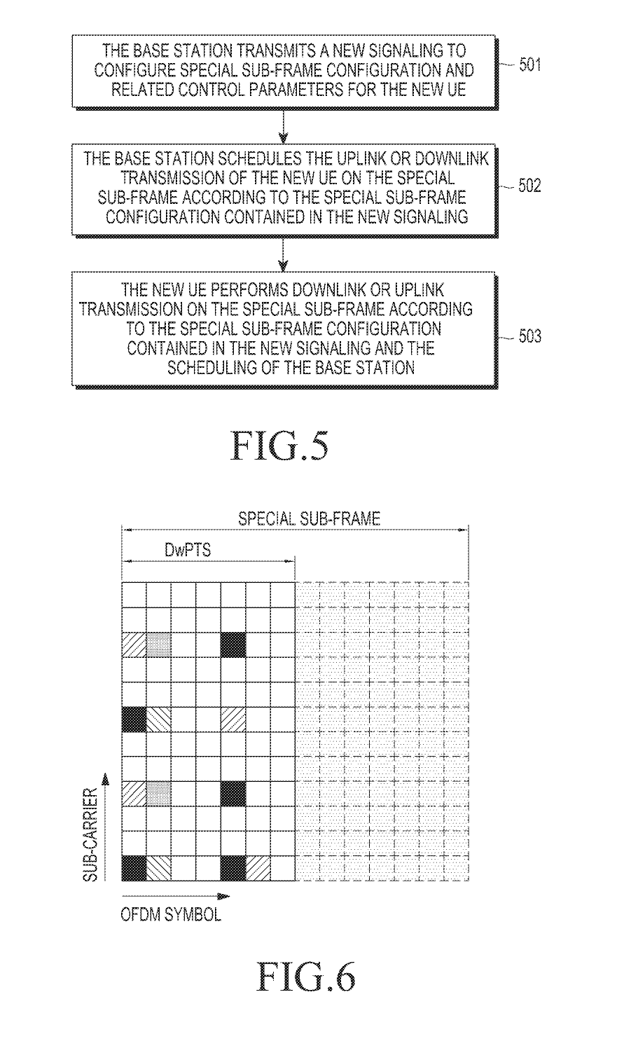

FIG. 6 is a schematic diagram illustrating a CRS pattern in a DwPTS according to an embodiment of the present disclosure.

Referring to FIG. 6, for the DMRS, if there is CRS in the data part of the DwPTS of the special sub-frame configuration configured for the new UE, the OFDM symbols used for transmitting the CRS should not be used for transmitting the DMRS. Some preferable DMRS patterns are described below, which are not limited in the present disclosure. For a normal CP, the DMRS pattern may be obtained based on the DMRS pattern according to the related art in the LTE TDD specification.

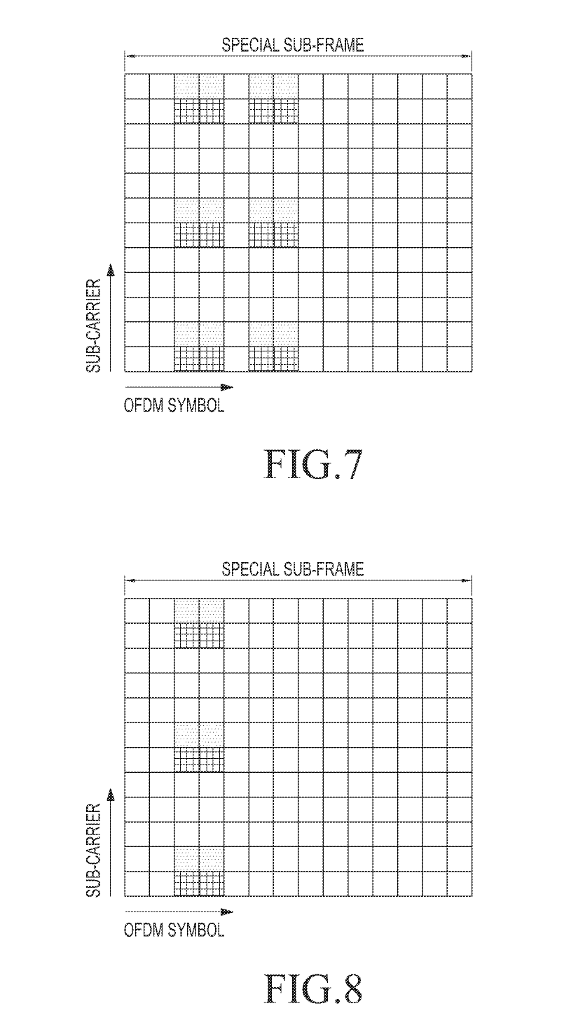

FIG. 7 is a schematic diagram illustrating a structure of DMRS of normal CP according to an embodiment of the present disclosure.

Referring to FIG. 7, if the number of OFDM symbols in the DwPTS is 8 or 7, the DMRS pattern defined for the special sub-frame configuration 1, 2, 6 or 7 in the LTE TDD specification may be used.

FIG. 8 is a schematic diagram illustrating a structure of DMRS of normal CP according to an embodiment of the present disclosure.

Referring to FIG. 8, if the number of OFDM symbols in the DwPTS is 6, 5 or 4, the DMRS pattern may be obtained through truncating the DMRS pattern defined for the special sub-frame configuration 1, 2, 6 or 7 in the LTE TDD specification (i.e., the segment in the former 6, 5 or 4 OFDM symbols of the DMRS pattern remains). For an extended CP, if the number of OFDM symbols in the DwPTS is 7 or 6, the DMRS pattern may be obtained based on the conventional DMRS pattern in the LTE TDD specification.

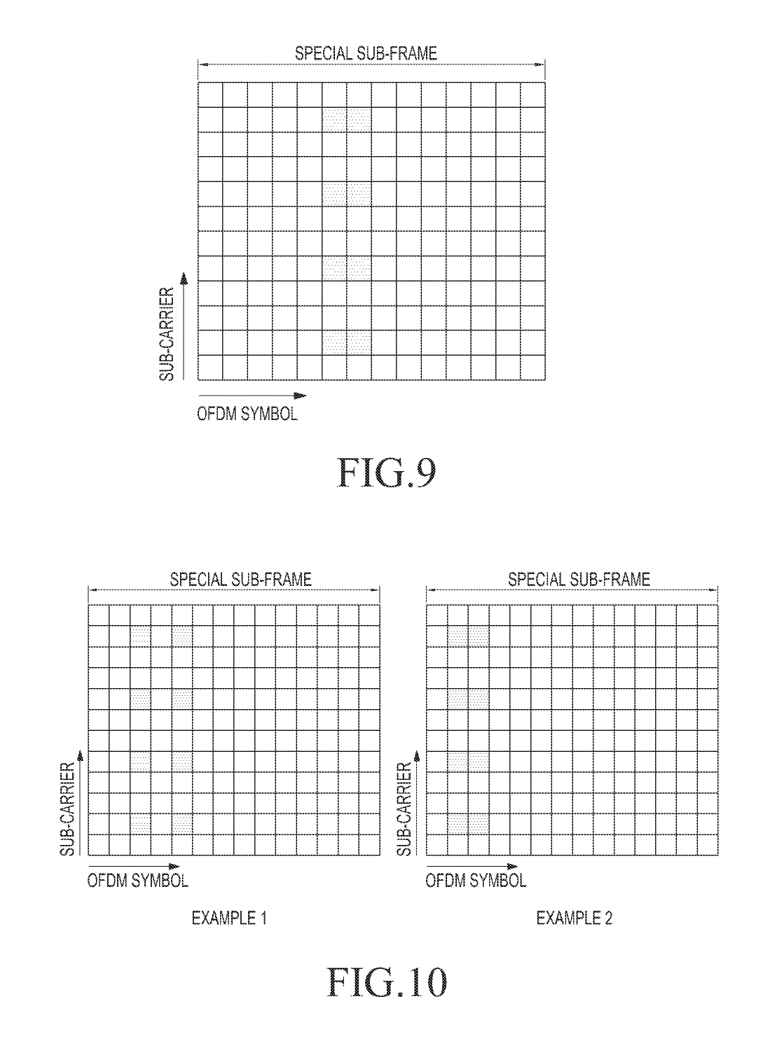

FIG. 9 is a schematic diagram illustrating a structure of DMRS of extended CP according to an embodiment of the present disclosure.

Referring to FIG. 9, the DMRS pattern defined for the special sub-frame configuration 1, 2, 3, 5, or 6 in the LTE TDD specification may be used. For the extended CP, if the number of OFDM symbols in the DwPTS is 5, and 4 CRS ports are configured, OFDM symbols 0, 1, and 3 are all used for transmitting the CRS, and OFDM symbols 2 and 4 are used for transmitting the DMRS.

FIG. 10 is a schematic diagram illustrating a structure of DMRS of extended CP according to an embodiment of the present disclosure.

As shown in FIG. 10, the DMRS pattern may be configured on OFDM symbols 2 and 4, but a DMRS RE for performing Walsh time spread corresponds to non-adjacent OFDM symbols, and thus time despreading performance is worse. Or, it is defined that DMRS based data transmission is only applied to a case that 1 or 2 CRS ports are configured. The new UE configured with 4 CRS ports only supports CRS based data transmission, and thus there is no CRS on adjacent OFDM symbols 1 and 2. As shown in example 2 of FIG. 10, the DMRS pattern may be defined on the OFDM symbols 1 and 2. The DMRS pattern shown in the example 2 of FIG. 10 may also applied to a case that the DwPTS of the extended CP contains 4 even 3 OFDM symbols.

For the DMRS, if there is no CRS in the data part of the DwPTS of the special sub-frame configuration configured for the new UE, the DMRS pattern may be defined flexibly. Some preferable DMRS patterns will be illustrated hereinafter, which are not limited in the present disclosure. For the normal CP, similar to the case that there is the CRS, the DMRS pattern may be obtained based on the conventional DMRS pattern defined in the LTE TDD specification. For example, if the number of OFDM symbols in the DwPTS is 8 or 7, the DMRS pattern shown in FIG. 7 may be still used. Alternatively, a time shifting version of the DMRS pattern shown in FIG. 7 is used.

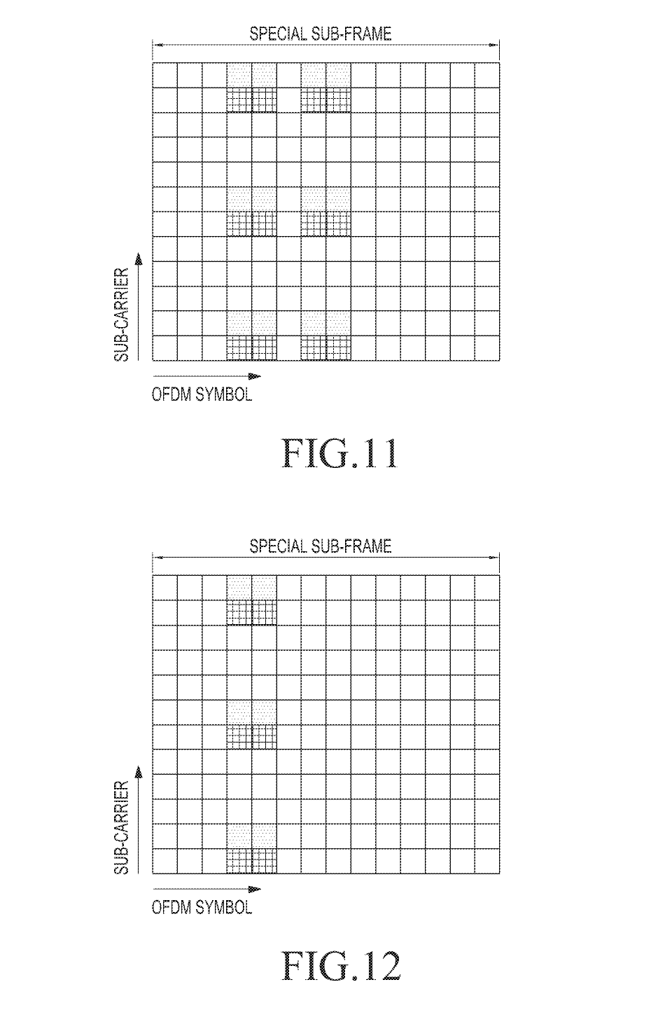

FIG. 11 is a schematic diagram illustrating a structure of DMRS of normal CP according to an embodiment of the present disclosure.

Referring to FIG. 11, the DMRS pattern may be shifted rightwards by one OFDM symbol. If the number of OFDM symbols in the DwPTS is 6 or 5, the DMRS pattern shown in FIG. 8 may be still used. Alternatively, a time shifting version of the DMRS pattern shown in FIG. 8 may be used.

FIG. 12 is a schematic diagram illustrating a structure of DMRS of normal CP according to an embodiment of the present disclosure.

Referring to FIG. 12, the DMRS pattern may be shifted rightwards by one OFDM symbol. The time shifting may guarantee that the DMRS is not transmitted on the 3-rd OFDM symbol in the DwPTS, so as to avoid the confliction with the P-SCH, and the middle 6 or 7 PRBs also support the DMRS based PDSCH transmission. For the extended CP, if the number of OFDM symbols in the DwPTS is 7 or 6, similar to the case that there is the CRS, the DMRS pattern may be obtained based on the DMRS pattern defined in the LTE TDD specification. For example, the DMRS pattern shown in FIG. 9 may be still used, or the time shifting version of the DMRS pattern shown in FIG. 9 is used.

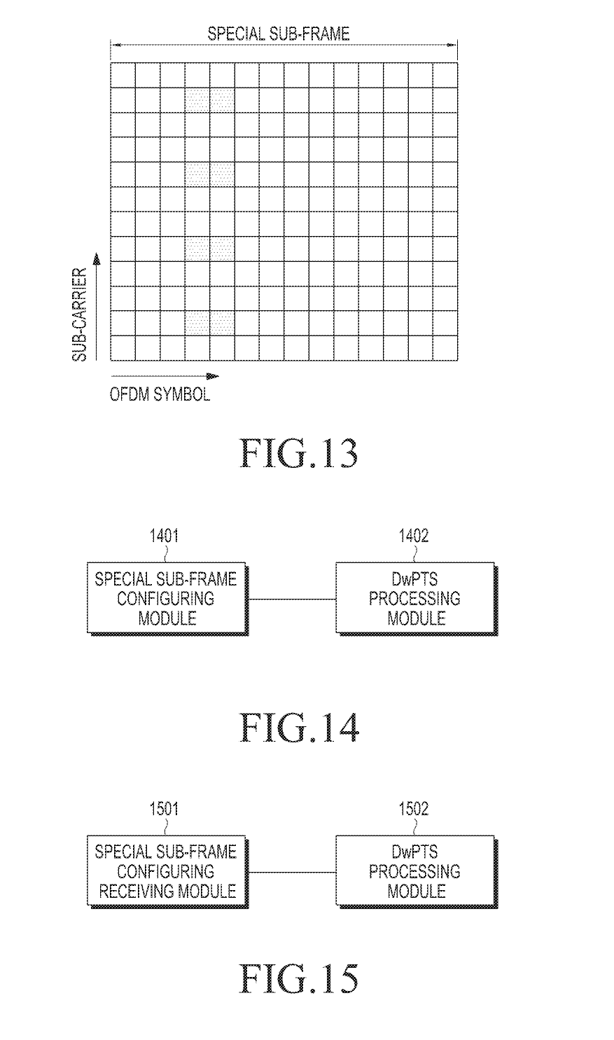

FIG. 13 is a schematic diagram illustrating a structure of DMRS of extended CP according to an embodiment of the present disclosure.

Referring to FIG. 13, the DMRS pattern may be shifted leftwards by one OFDM symbol. In this way, the DMRS pattern does not interfere with the OFDM symbols where the P-SCH is located, and is adjacent to the middle point of the DwPTS. For the extended CP, if the number of OFDM symbols in the DwPTS is 5, because there is no CRS in the data part of the DwPTS, the OFDM symbols 3 and 4 may be mapped to the DMRS pattern. At this time, the DMRS pattern shown in FIG. 13 may be still used.

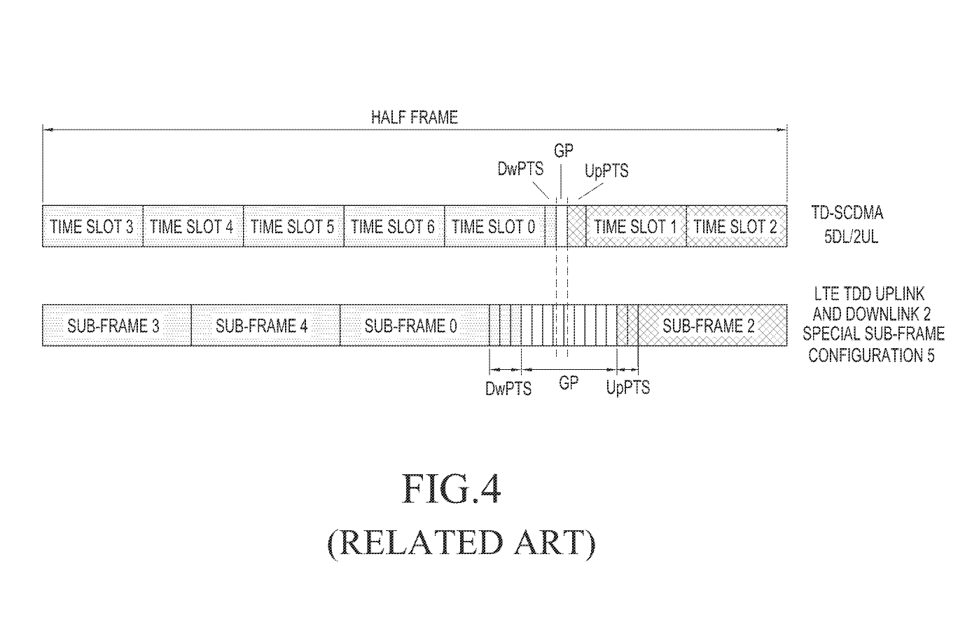

An embodiment of the present disclosure is described below. As shown in FIG. 4, the normal CP is taken as an example. When the TD-SCDMA(5DL/2UL) system and the LTE TDD (uplink and downlink configuration 2) system coexist, suppose the special sub-frame configuration that the number of OFDM symbols in the DwPTS is 3, the resources of 3 OFDM symbols on the downlink direction are wasted. In order to increase the utilization rate of downlink resources, new special sub-frame configuration that the number of OFDM symbols in the DwPTS is 6 may be defined. Herein, the UpPTS may contain 1, 2 or more SC-FDMA symbols, which is not limited.

The base station may use the broadcast signaling according to the related art to transmit the special sub-frame configuration, and configures the number of OFDM symbols in the DwPTS as 3. In this way, for the old UE, the DwPTS cannot be used for transmitting the PDSCH, and thus cannot be used for transmitting broadcast information.

In the special sub-frame configuration of the LTE TDD system, the base station can only configure the special sub-frame configuration that the number of OFDM symbols in the DwPTS is 3; otherwise the uplink and downlink interference cannot be avoided when the LTE TDD system and the TD-SCDMA system coexist. According to an exemplary embodiment of the present disclosure, the base station transmits the above new signaling to the UE to notify the UE of the new special sub-frame configuration that the number of OFDM symbols in the DwPTS is 6, so that the base station may transmit the PDSCH in the DwPTS for the UE.

According to an exemplary embodiment of the present disclosure, the CRS may not be transmitted on other OFDM symbols except 1 or 2 OFDM symbols in the front of DwPTS, the PDSCH transmission performed for the new UE in the DwPTS is demodulated only based on the DMRS, and the DMRS pattern shown in FIG. 12 may also be used. Alternatively, in the signaling in which the base station notifies the new UE of the new special sub-frame configuration, it is indicated through one bit whether the CRS is included in the data part of the DwPTS for the new UE. When the signaling indicates that the CRS is included in the data part of the DwPTS, the CRS demodulation based downlink transmission mode may be configured for the new UE. The available CRS pattern is as shown in FIG. 6.

When the signaling indicates that there is no CRS in the data part of the DwPTS, the PDSCH transmission of the new UE in the DwPTS may be demodulated only based on the DMRS, and the DMRS pattern shown in FIG. 12 may be used. Through the method, the base station may fully utilize available downlink resources, so as to increase resource utilization rate. The base station has larger flexibility, and may determine to perform the CRS based downlink data transmission mode or the DMRS based downlink data transmission mode for the new UE. When there is no CRS in the data region of the DwPTS configured by the base station for the new UE and the base station makes the new UE adopt the DMRS based data transmission, it is easy to implement interference coordination and use CoMP technology to improve system performance.

According to the above method, an exemplary embodiment of the present disclosure also provides a UE and a base station.

FIG. 14 is a schematic diagram illustrating a structure of a base station according to an exemplary embodiment of the present disclosure.

Referring to FIG. 14, the base station includes a special sub-frame configuring module 1401 and a DwPTS processing module 1402.

The special sub-frame configuring module 1401 is configured to notify the old UE of the special sub-frame configuration by the broadcast signaling according to the related art, and to notify the new UE of the special sub-frame configuration according to the method of the present disclosure.

The DwPTS processing module 1402 is configured to schedule and transmit the PDSCH in the DwPTS for the old UE with the method of the LTE TDD system according to the special sub-frame configuration configured in the broadcast signaling by the base station according to the related art, and schedule and transmits the PDSCH in the DwPTS for the new UE with the method of the present disclosure according to the new special sub-frame configuration configured in the signaling of an exemplary embodiment of the present disclosure.

FIG. 15 is a schematic diagram illustrating a structure of UE according to an exemplary embodiment of the present disclosure.

Referring to FIG. 15, the UE includes a special sub-frame configuration receiving module 1501 and a DwPTS processing module 1502.

The special sub-frame configuration receiving module 1501 is configured to receive the special sub-frame configuration transmitted by the base station through the broadcast signaling according to the related art, and to receive the new special sub-frame configuration transmitted by the base station with the method of the present disclosure, and work preferentially according to the special sub-frame configuration transmitted with the method of the present disclosure.

The DwPTS processing module 1502 is configured to, when there is no new special sub-frame configuration transmitted with the method of the present disclosure, work according to the special sub-frame configuration configured in the broadcast signaling according to the related art, to receive the scheduling information and PDSCH transmitted by the base station in the DwPTS, and when there is the new special sub-frame configuration transmitted with the method of the present disclosure, to receive the scheduling information and PDSCH in the DwPTS with the method of the present disclosure according to the new special sub-frame configuration indicated by the signaling of an exemplary embodiment of the present disclosure.

The UpPTS processing method of the present disclosure is described below.

In the LTE TDD, the UpPTS is only used for transmitting the SRS or the random access signal with a format 4. In order to decrease complexity, an exemplary embodiment of the present disclosure suggests that the base station configures the new special sub-frame configuration for the new UE, and the newly added SC-FDMA symbols are only used for transmitting the SRS when the number of SC-FDMA symbols of the UpPTS is larger than 2.

In the LTE FDD, there are 10 SC-FDMA symbols for transmitting the SRS in each frame at most. Because of the limit of frame structure in the LTE TDD system, some sub-frames are downlink sub-frames, which cannot be used for transmitting the SRS, which results in that the number of available SRS symbols is small. In order to increase the SRS capacity of the LTE TDD system, the present disclosure provides two methods as follows.

In the first method, for the SRS symbols for transmitting the SRS do not exist because of a downlink subframe, the SC-FDMA symbols of the newly added UpPTS replace such SRS symbols to transmit the SRS. For example, for TDD uplink and downlink configuration 2, sub-frames 0, 3 and 4 in each half frame are downlink sub-frames, and sub-frame 2 is an uplink sub-frame. When the UpPTS contains 2 SC-FDMA symbols, 3 SC-FDMA symbols including the sub-frame 2 may be provided for transmitting the SRS, and the SRS symbol location corresponding to the sub-frames 3 and 4 is unavailable. When the UpPTS contains 4 SC-FDMA symbols, 2 SC-FDMA symbols are identical to those in the LTE TDD, and are mapped to SRS symbols with indexes k_{SRS} equal to 0 and 1. Another two SC-FDMA symbols replace the sub-frames 3 and 4 and are mapped to the SRS symbols with indexes k_{SRS} equal to 3 and 4. The last SC-FDMA symbol of sub-frame 2 is still mapped to the SRS symbol with index k_{SRS} equal to 2. In this way, there are 5 SRS symbols in the half frame of the LTE TDD, so as to have the same SRS capacity with the LTE FDD.

The second method is if there are additional available SC-FDMA symbols in UpPTSs after adopting the first method, such SC-FDMA symbols in the UpPTSs replace the last SC-FDMA symbol of general uplink sub-frame to transmit the SRS. The TDD uplink and downlink configuration 2 is taken as an example. When the UpPTS contains 5 SC-FDMA symbols, 2 SC-FDMA symbols are identical to those in the LTE TDD and are mapped to SRS symbols with indexes k_{SRS} equal to 0 and 1. Another two SC-FDMA symbols replace the sub-frames 3 and 4, and are mapped to SRS symbols with indexes k_{SRS} equal to 3 and 4. Another SC-FDMA symbol replaces the sub-frame 2 and is mapped to the SRS symbol with index k_{SRS} equal to 2. In this way, there are 5 SRS symbols in the half frame of the LTE TDD, so as to have the same SRS capacity with the LTE FDD. The method may avoid the SRS transmission on the normal sub-frame and decrease the influence on the PUSCH and the PUCCH.

In the above two methods, it is only necessary to define that the SC-FDMA symbols of the newly defined UpPTS are associated with the SC-FDMA symbols of uplink sub-frame, the cell specific signaling and UE specific signaling of SRS defined in the conventional LTE TDD may be reused.

As shown in FIG. 4, the normal CP is taken as an example. When the TD-SCDMA(5DL/2UL) system and the LTE TDD (uplink and downlink configuration 2) system coexist, suppose the special sub-frame configuration that the number of SC-FDMA symbols in the UpPTS is 2 is adopted, the resources of 4 SC-FDMA symbols on the uplink direction are wasted actually. In order to increase the utilization rate of uplink resources, new special sub-frame configuration that the number of SC-FDMA symbols in the UpPTS is 5 may be defined. The number of OFDM symbols in the DwPTS is not limited. The base station may use the broadcast signaling according to the related art to transmit the special sub-frame configuration, and configure the number of SC-FDMA symbols in the UpPTS as 2. In this way, for the old UE, UpPTS resources of 2 symbols may only be used. Afterwards, according to the method of the present disclosure, the base station transmits the above new signaling to the new UE to notify the new UE of the new special sub-frame configuration that the number of SC-FDMA symbols in the UpPTS is 5, so that the base station may make the new UE transmit more SRSs in the UpPTS.

According to the method of the present disclosure, 5 SC-FDMA symbols in the UpPTS may be mapped to 5 SRS indexes in the half frame of the LTE TDD, i.e., replace the location of sub-frames 3 and 4 and the location of uplink sub-frame 2. At present, the cell specific signaling and UE specific signaling of the SRS defined in the LTE TDD may be reused. For example, Table 3 shows a mapping relation between the SC-FDMA symbols in the UpPTS and SRS symbol indexes, which is simple one-to-one mapping.

Table 3 shows SRS symbol indexes k_{SRS} obtained through mapping UpPTS.

TABLE 3

| SC-FDMA symbols index | SRS symbol indexes |
|---|---|
| in UpPTS | k_{SRS} |
| 0 | 0 |
| 1 | 1 |
| 2 | 2 |
| 3 | 3 |
| 4 | 4 |

Alternatively, if the new special sub-frame configuration that the number of SC-FDMA symbols in the UpPTS is 4 is adopted, where the number of OFDM symbols in the DwPTS is not limited herein, the base station may use the broadcast signaling according to the related art to transmit the special sub-frame configuration, and configure the number of SC-FDMA symbols in the UpPTS as 2. In this way, for the old UE, the UpPTS resources of 2 symbols may be used. Afterwards, according to the method of the present disclosure, the base station transmits the above signaling to the new UE to notify the new UE of the new special sub-frame configuration. The number of SC-FDMA symbols in the UpPTS is 4, so that the base station may make the new UE transmit more SRSs in the UpPTS.

According to the method of the present disclosure, 4 SC-FDMA symbols in the UpPTS may be mapped to 4 SRS indexes in the half frame of the LTE TDD, i.e., replace the location of downlink sub-frames 3 and 4. At present, the cell specific signaling and UE specific signaling of SRS defined in the conventional LTE TDD specification may be reused. For example, Table 4 shows a mapping relation between the SC-FDMA symbols in the UpPTS and SRS symbol indexes, and the last SC-FDMA symbol of the uplink sub-frame 2 is still mapped to a SRS symbol index k_{SRS} equal to 2.

Table 4 shows SRS symbol indexes k_{SRS} obtained through mapping UpPTS.

TABLE 4

| SC-FDMA symbol indexes in | SRS symbol indexes |
|---|---|
| UpPTS | k_{SRS} |
| 0 | 0 |
| 1 | 1 |
| 2 | 3 |
| 3 | 4 |

Through the above method, the SRS capacity in the LTE TDD system may be increased, the SRS transmission on the normal sub-frame may be avoided and influence on the PUSCH and the PUCCH may be decreased.

According to the above method, an exemplary embodiment of the present disclosure also provides a UE and a base station.

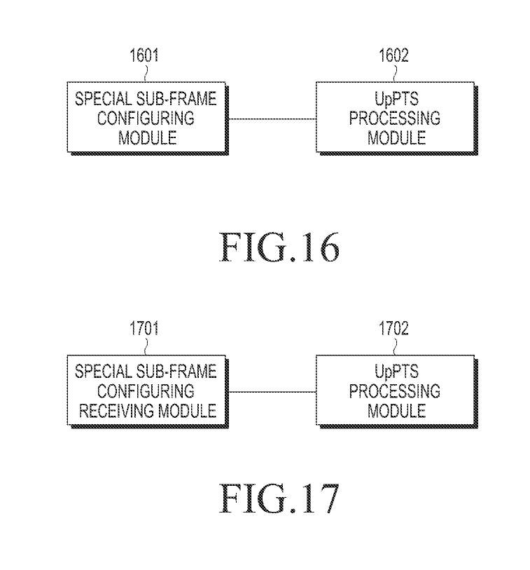

FIG. 16 is a schematic diagram illustrating a structure of a base station according to an exemplary embodiment of the present disclosure.

Referring to FIG. 16, the base station includes a special sub-frame configuring module 1601 and an UpPTS processing module 1602.

The special sub-frame configuring module 1601 is configured to employ the broadcast signaling according to the related art to notify the old UE of the special sub-frame configuration, and to notify the new UE of the special sub-frame configuration according to the method of the present disclosure.

The UpPTS processing module 1602 is configured to receive the SRS in the UpPTS with the LTE TDD method for the old UE according to the special sub-frame configuration transmitted through the broadcast signaling according to the related art by the base station and other configuration information of the SRS, and to receive the SRS in the UpPTS with the method of the present disclosure for the new UE according to the new special sub-frame configuration indicated by the signaling of an exemplary embodiment of the present disclosure and other configuration information of the SRS.

FIG. 17 is a schematic diagram illustrating a structure of UE according to an exemplary embodiment of the present disclosure.

Referring to FIG. 17, the UE includes a special sub-frame configuration receiving module 1701 and an UpPTS processing module 1702.

The special sub-frame configuration receiving module 1701 is configured to receive the special sub-frame configuration transmitted by the base station through the broadcast signaling according to the related art, and to receive the new special sub-frame configuration transmitted by the base station with the method of the present disclosure, and work preferentially according to the special sub-frame configuration transmitted with the method of the present disclosure.

The UpPTS processing module 1702 is configured to, when there is no new special sub-frame configuration transmitted with the method of the present disclosure, transmit the SRS on the UpPTS according to the special sub-frame configuration configured according to the broadcast signaling according to the related art and other configuration information of the SRS, and when there is the new special sub-frame configuration transmitted with the method of the present disclosure, to transmit the SRS on the UpPTS with the method of the present disclosure according to the new special sub-frame configuration indicated by the signaling of an exemplary embodiment of the present disclosure and other configuration information of the SRS.

The foregoing is only preferred embodiments of the present disclosure and is not used to limit the present disclosure. Any modification, equivalent substitution and improvement without departing from the principle of the present disclosure are within the protection scope of the present disclosure.

1. A method for transmitting signals on a special sub-frame of Long Term Evolved (LTE) Time Division Duplex (TDD), the method comprising:
transmitting, by a base station, a new configuration signaling to a User Equipment (UE) of a new version, to configure special sub-frame configuration for the UE of the new version; and
performing, by the base station and the UE of new version, uplink or downlink transmission of the UE of new version on the special sub-frame according to the configuration signaling.

2. The method of claim 1, wherein
configuring one piece of special sub-frame configuration defined in a LTE TDD specification, or
configuring new special sub-frame configuration other than the special sub-frame configuration defined in the LTE TDD specification, or
configuring the special sub-frame configuration defined in the LTE TDD specification or the new special sub-frame configuration other than the special sub-frame configuration defined in the LTE TDD specification.

3. The method of claim 1, wherein the configuration signaling is a cell specific signaling.

4. The method of claim 1, wherein the configuration signaling is a UE specific signaling.

5. The method of claim 1, wherein the performing of the uplink or downlink transmission comprises:
when performing downlink transmission on a Downlink Pilot Time Slot (DwPTS), the base station does not transmit a Cell specific Reference Signal (CRS) on other Orthogonal Frequency Division Multiplexing (OFDM) symbols except 1 or 2 OFDM symbols in the front of DwPTS, and the UE of the new version demodulates Physical Downlink Shared Channel (PDSCH) transmission on the DwPTS based on a Demodulation Reference Signal (DMRS).

6. The method of claim 1, wherein the configuration signaling transmitted by the base station comprises indication information for indicating whether there is a Cell specific Reference Signals (CRS) except the CRS on 1 or 2 Orthogonal Frequency Division Multiplexing (OFDM) symbols in the front of Downlink Pilot Time Slot (DwPTS).

7. The method of claim 6, wherein, when it is determined according to the indication information that there is the CRS except the CRS on the 1 or 2 OFDM symbols in the front of DwPTS, the UE of new version demodulates Physical Downlink Shared Channel (PDSCH) transmission on the DwPTS based on the CRS; or
the UE of new version determines, according to previous configuration, to demodulate PDSCH transmission on the DwPTS based on the CRS or demodulate PDSCH transmission on the DwPTS based on a DMRS.

8. The method of claim 6, wherein, when it is determined according to the indication information that there is no CRS except the CRS on the 1 or 2 OFDM symbols in the front of DwPTS, the UE of new version demodulates PDSCH transmission on the DwPTS based on a DMRS.

9. The method of claim 1, wherein, the Cell specific Reference Signals (CRS) pattern on a Downlink Pilot Time Slot (DwPTS) is the CRS transmission location of the former N Orthogonal Frequency Division Multiplexing (OFDM) symbols in a CRS pattern of normal sub-frame defined in a LTE TDD specification, wherein N is the number of OFDM symbols in the DwPTS in the special sub-frame configuration.

10. The method of claim 1, wherein when there is a Cell specific Reference Signals (CRS) besides a CRS on 1 or 2 Orthogonal Frequency Division Multiplexing (OFDM) symbols in the front of a Downlink Pilot Time Slot (DwPTS) in the special sub-frame configuration, a Demodulation Reference Signal (DMRS) pattern and a CRS pattern do not overlap in OFDM symbols in the DwPTS.

11. The method of claim 1, wherein, for a normal Cyclic Prefix (CP), when the special sub-frame configuration is that the number of Orthogonal Frequency Division Multiplexing (OFDM) symbols in a Downlink Pilot Time Slot (DwPTS) is N, a Demodulation Reference Signal (DMRS) pattern is DMRS transmission location in the former N OFDM symbols in a DMRS pattern defined for special sub-frame configuration 1, 2, 6 or 7 in a LTE TDD specification, wherein N is equal to 4, 5 or 6.

12. The method of claim 1, wherein, for an extended Cyclic Prefix (CP), when the special sub-frame configuration is that a Downlink Pilot Time Slot (DwPTS) contains 5 Orthogonal Frequency Division Multiplexing (OFDM) symbols and 4 CRS ports are configured, a Demodulation Reference Signal (DMRS) pattern is configured on OFDM symbols 2 and 4.

13. The method of claim 10, wherein, for an extended Cyclic Prefix (CP), when the special sub-frame configuration is that a DwPTS contains 5 Orthogonal Frequency Division Multiplexing (OFDM) symbols,
when 1 or 2 CRS ports is configured, PDSCH transmission on the DwPTS is performed based on the Demodulation Reference Signal (DMRS), and the DMRS pattern is configured on the OFDM symbols 1 and 2; when 4 CRS ports are configured, the PDSCH transmission on the DwPTS is performed based on the CRS.

14. The method of claim 1, wherein a Demodulation Reference Signal (DMRS) pattern is configured on two adjacent Orthogonal Frequency Division Multiplexing (OFDM) symbols other than the third OFDM symbol in a Downlink Pilot Time Slot (DwPTS).

15. The method of claim 1, wherein, for a normal Cyclic Prefix (CP), a Demodulation Reference Signal (DMRS) pattern is DMRS transmission location of the former N Orthogonal Frequency Division Multiplexing (OFDM) symbols in a DMRS pattern of normal sub-frame defined in a LTE TDD specification, or DMRS transmission location of the former N OFDM symbols which are obtained through performing time shifting for the DMRS pattern of normal sub-frame defined in the LTE TDD specification.

16. The method of claim 1, wherein when the special sub-frame configuration is that the number of Orthogonal Frequency Division Multiplexing (OFDM) symbols in an Uplink Pilot Time Slot (UpPTS) is larger than 2, Single-carrier-Frequency Division Multiple Access (SC-FDMA) symbols of newly added UpPTS are only used for transmitting a Sounding Reference Signals (SRS).

17. The method of claim 16, wherein when Sounding Reference Signals (SRS) symbols for transmitting the SRS do not exist because of an uplink sub-frame, the Single-carrier-Frequency Division Multiple Access (SC-FDMA) symbols of newly added Uplink Pilot Time Slot (UpPTS) are mapped to the SRS symbols for transmitting the SRS.

18. The method of claim 16, wherein the Single-carrier-Frequency Division Multiple Access (SC-FDMA) symbols of newly added Uplink Pilot Time Slot (UpPTS) are mapped to SRS symbols for transmitting the SRS corresponding to a general uplink sub-frame and the SRS symbols for transmitting the SRS which do not exist because of a downlink sub-frame.

19. A base station, comprising:
a special sub-frame configuring module configured to transmit a new configuring signaling to a User Equipment (UE) of a new version to notify the UE of the new version of special sub-frame configuration; and
a Downlink Pilot Time Slot (DwPTS) processing module configured to schedule and transmit a Physical Downlink Shared Channel (PDSCH) on a DwPTS for the UE of the new version according to the special sub-frame configuration.

20. A User Equipment (UE), comprising:
a special sub-frame configuration receiving module configured to receive a broadcast signaling and a new configuration signaling transmitted by a base station, and to configure special sub-frame configuration of the UE according to the new configuration signaling; and
a Downlink Pilot Time Slot (DwPTS) processing module configured to receive scheduling information and a Physical Downlink Shared Channel (PDSCH) in a DwPTS according to the special sub-frame configuration configured by the special sub-frame configuration receiving module.

21. A base station, comprising:
a special sub-frame configuring module configured to transmit a new configuring signaling to a User Equipment (UE) of a new version to notify the UE of the new version of special sub-frame configuration; and
an Uplink Pilot Time Slot (UpPTS) processing module configured to receive a Sounding Reference Signals (SRS) to the UE of the new version according to the special sub-frame configuration of the UE of the new version.

22. A User Equipment (UE), comprising:
a special sub-frame configuration receiving module configured to receive a broadcast signaling and a new configuration signaling transmitted by a base station, and to configure special sub-frame configuration of the UE according to the new configuration signaling; and
an Uplink Pilot Time Slot (UpPTS) processing module configured to transmit a Sounding Reference Signals (SRS) in an UpPTS according to the special sub-frame configuration configured by the special sub-frame configuration receiving module.

23. A method for transmitting signals on a special sub-frame of Long Term Evolved (LTE) Time Division Duplex (TDD), the method comprising:
receiving, at a User Equipment (UE), a new configuration signaling to configure special sub-frame configuration for the UE; and
performing, at the UE, uplink and downlink transmission on the special sub-frame according to the new configuration signaling.
